(19) United States
(12) Patent Application Publication
(10) Pub. No.: US 2017/0040930 A1
(43) Pub. Date: Feb. 9, 2017

(54) FINNED PASSIVE PVT SYSTEM WITH ADJUSTABLE ANGLE INSULATING REFLECTORS

(71) Applicants: Behrooz Mirzaei Ziapour, West Azarbayjan (IR); Vahid Palideh, West Azarbayjan (IR)

(72) Inventors: Behrooz Mirzaei Ziapour, West Azarbayjan (IR); Vahid Palideh, West Azarbayjan (IR)

(21) Appl. No.: 15/299,360

(22) Filed: Oct. 20, 2016

Related U.S. Application Data
(63) Continuation-in-part of application No. PCT/IB2015/054606, filed on Jun. 18, 2015.

(30) Foreign Application Priority Data
Dec. 11, 2015 (IR) 13945014000301030

(51) Int. Cl. H02S 20/23; H02S 40/42; H02S 40/22

(52) U.S. Cl. CPC H02S 20/23; H02S 40/22; H02S 40/425

(57) ABSTRACT

A photovoltaic-thermal device includes a housing unit, a photovoltaic panel, a fluid collector storage, adjustable angle reflector plates and an absorber plate. The photovoltaic panel is placed within the housing unit and includes a plurality of photoelectric cells. The adjustable angle reflector plates focus and distribute the sunlight on the photovoltaic cells. The fluid collector storage is within the housing unit and configured to store fluid. The absorber plate is within the housing unit between the photovoltaic panel and the fluid collector storage and configured to collect heat by absorbing electromagnetic radiations and to pass the collected heat to the fluid collector. The reflectors may be covered by a light sensor and may automatically close at nights and cloudy times.

### CROSS REFERENCE TO RELATED APPLICATION

This application is continuation-in-part of, and claim priority with respect to all subject matter disclosed by International Application No. PCT/IB2015/054606, filed on Jun. 18, 2015, entitled “Photovoltaic-Thermal Passive System,” the entire content of which is incorporated herein by reference and claims priority to Iran Application Serial Number 139450140003010302, filed on Dec. 11, 2015, the entire content of which is incorporated herein by reference

### TECHNICAL FIELD

The present disclosure relates generally to solar energy collection and, more particularly, to solar collection in combination with water heating.

### BACKGROUND

People have always been fascinated by the tremendous energy output of the sun and has spent a great deal of effort in the past to utilize such energy.

Panels for absorbing and utilizing solar energy are well-known and in wide-spread use. Such panels employ the heat energy from the sun to warm liquids or gases for various heating and cooling purposes. Other panels employ photovoltaic cells to convert solar energy directly into electrical energy. The use of photovoltaic cells has been limited because of the high cost of said cells and the fact that only about twelve percent, more or less, of the solar radiation can be converted into electricity. Prior art devices have used reflectors for the purpose of concentrating the solar energy upon photovoltaic cells in an effort to improve their output. However, the increased temperature caused by the uneven distribution of the concentrated solar rays upon the cells together with inadequate cooling often leads to their rapid deterioration.

The curvature of the reflectors used throughout the art covers all the conic sections, but none produce a uniform distribution of energy over the surface of the cells, or a constant selected angle of incidence of the rays after a single reflection from the mirror surfaces.

Since less than twenty-five percent of the radiation impinging on the solar cell is converted into electrical energy, the remaining approximately seventy-five percent which must be removed from the cell to prevent their overheating is available for domestic purposes such as heating. Thus the calculations based upon the percentage of electrical energy plus the thermal energy utilized for domestic purposes, will bring the cost per watt of utilized solar energy within the cost per watt of energy derived from other sources.

To provide maximum concentration of solar radiation per unit area of concentrated rays, it is necessary to employ reflectors that fit together with a high degree of close packing while satisfying the conditions of uniform distribution of the reflected solar radiation over the photovoltaic cells, and a uniform angle of incidence of the solar rays after a single reflection from the reflectors. These conditions require cone-shaped reflector units of hexagonal shape.

Accordingly, there is a need for more uniform distribution of energy over the surface of the photovoltaic cells, and additional need to capture additional amounts of the solar energy

### SUMMARY

In one general aspect, the instant application describes a photovoltaic-thermal device that includes a housing unit, having a first end and a second end, a photovoltaic panel supported within the housing unit, between the first end and second end of the housing. The photovoltaic panel can include a plurality of photoelectric cells configured to generate an electrical output in response to incident electromagnetic radiations, the photovoltaic panel. In an aspect, a first adjustable angle reflector plate can be mechanically coupled to the first end of the housing and a second adjustable angle reflector plate can be mechanically coupled to the second end of the housing. The first adjustable angle reflector plate and the second adjustable angle reflector plate can each be configured with adjustability to reflect solar energy onto the photovoltaic panel. The photovoltaic-thermal device can also include a fluid collector storage placed within the housing unit, and configured to store fluid, and an absorber plate supported within the housing unit. The absorber plate can be between the photovoltaic panel and the fluid collector storage and configured to collect heat by absorbing electromagnetic radiations and to pass the collected heat to the fluid collector.

The above general aspect may include one or more of the following features. In one aspect, the first adjustable angle reflector plate and the second reflector plate can be configured to distribute solar energy substantially evenly over a surface of the photovoltaic panel. In another aspect, the first adjustable angle reflector plate and the second reflector plate can each be configured to be foldable to a closed position, the closed position being face down on the photovoltaic panel.

In an aspect, each of the first adjustable angle reflector plate and the second adjustable angle reflector plate can be configured to substantially cover the photovoltaic panel when each of the first adjustable angle reflector and the second adjustable angle reflector are in the folded position. In a further aspect, the first adjustable angle reflector plate and the second adjustable angle reflector plate reflectors can each include a glass cover and an outer layer, the outer layer, the outer layer can be a heat insulating material. In a related aspect, the outer layer formed of heat insulating material can be configured to reduce heat transfer from the housing when the first adjustable angle reflector plate and the second adjustable angle reflector plate are in the closed position.

In one exemplary implementation, the photovoltaic-thermal device can include a fin panel supported within the housing unit between the absorber plate and the fluid collector storage. The fin panel, in an aspect, can be configured to increase an amount of the transfer of the absorbed heat from the absorber plate to the fluid collector storage. In an aspect, the absorber plate can separate the photovoltaic panel from the fluid collector storage.

In an exemplary implementation, the fluid collector storage can include a water collector storage. In another exemplary implementation, the housing unit can be configured for mounting to a house roof at an inclination angle. The inclination angle can be selected, for example, to maximize an amount of solar radiation incident in a perpendicular direction on the photovoltaic panel.

In another exemplary implementation, the photovoltaic-thermal device can be configured to transfer heat from the absorber plate to the fluid storage collector without using a pump and a fluid pipe.

The foregoing and other objects, features, aspects and advantages of the present invention will become more apparent from the following detailed description of the present application when taken in conjunction with the accompanying drawing.

### BRIEF DESCRIPTION OF THE DRAWINGS

Features of the subject technology are set forth in the appended claims. However, for purpose of explanation, several implementations of the subject technology are set forth in the following figures.

FIG. 1 illustrates an exemplary finned passive PVT system according to disclosed aspects.

FIG. 2 illustrates the FIG. 1 finned passive PVT system with reflector structures in one exemplary folded position.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

In one implementation, the instant application describes a photovoltaic-thermal (PVT) module including a photovoltaic (PV) panel and a thermal collector for co-generation of heat and electricity. The PV panel may include solar cell array. The solar cell array may be subjected to a solar radiation for generating electrical power for a variety of purposes, including powering conventional appliances. The solar cell array may not convert all the solar radiation into the electrical power. Some of the radiation may, for example, be converted into heat, which may be absorbed by the thermal collector.

The thermal collector may be an integrated collector-storage solar water heater (ICSSWH). The ICSSWH is combined with the PV panel in a single housing unit and may include an absorber plate and a fluid collector storage. The fluid collector storage may be a water collector storage. Due to its simple and compact structure, the ICSSWH may offer a promising approach for the solar water heating in the varied climates.

The absorber plate can be configured to absorb the wasted heat from the solar cells arranged in the PV panel, and transfer the heat to the water collector storage. This transfer of heat from the solar cells to the water collector storage heats the water inside the collector storage. The heated water can be used for variety of purposes inside the house, including providing hot water for the house. The transfer of the heat from the solar cells to the water collector storage may also result in increasing the productivity of the solar cells by keeping the solar cells cool. That is, the transfer of the heat can prevent the increase of the temperature of the solar cells, which result in reduction of their productivity.

In one implementation, the PVT system is a PVT passive system. To this end, the PVT passive system may omit a PV driven water pump, yet still maintain a flow of water inside the collector.

The PVT passive system of the instant application may be advantageous compared to the prior art systems for several reasons. For example, in the prior art system, the water collector storage may be separated from the absorber plate (e.g., not be located in the same housing unit as the absorber plate) and may be connected to the absorber plate via various pipes. To this end, the water may travel from the water collector storage to the vicinity of the absorber plate via a first pipe. In an aspect, water in the vicinity of the absorber plate may be heated by transfer of heat from the solar radiation to the water through the absorber plate. The heated water may then be transferred back to the water collector storage through a second pipe. In an implementation, a pump may provide this circulation of the water. In another implementation, circulation to heat the water inside the water collector can be provided without a pump. The water can be directly heated through the absorber plate since the water collector heater is located within the same housing unit as the absorber plate. To this end, the PVT passive system of the instant application may be more economical to use than that the prior art system since the PVT passive system of the instant application does not require a pump or a pluming. Furthermore, the PVT passive system of the instant application may be more efficient in heating the water inside the water collector storage since it can avoid the heat loss during the transfer of the heated water through return pipes to the water collector storage. Furthermore, the PVT passive system of the instant application has a simpler design, thus obtaining lower maintenance and repair costs than that of the prior art. In addition, the PVT passive system of the instant application can occupy less space than that of the prior art.

By start of day and radiation of solar energy on the PV panel, the panel can generate electricity, which can be used for variety of purposes. For example, the electricity can be used to provide lighting for the house. For another example, the electricity can be used to provide power for electrical appliances within the house such as, dishwasher, washing machine, microwave, etc. For yet another example, the electricity can be used to charge a battery. During the process of converting the solar energy into electricity, the solar cells' temperature may increase. This temperature increase may result in decrease in efficiency of the solar cells. However, this increased temperature may be absorbed by the absorber plate and transferred to the water collector storage hence cooling down the solar cells. In addition to absorbing the heat generated from the electromagnetic radiations incident on the plurality of the photoelectric cells, the absorber plate can absorb heat incident directly on the absorber plate due to existing space between the plurality of photoelectric cells. The absorber plate transfers the absorbed heat to the water collector storage. The transfer of heat can raise the temperature of the water within the water collector storage.

The water near the surface of the absorber plate may be heated first. This heated water may have a lesser density than the water located farther away from the absorber plate. This difference in density may cause a pressure difference between the water located near the absorber plate and the water located farther away from the absorber plate, which may in turn result in circulation of the water within the water collector storage. As a result of this circulation, the water heated near the absorber plate may travel to the bottom and the water at the bottom of the water collector storage may travel to the top near the absorber plate. This movement may be slow and may be suitable for an environment in which slow movement of the water is desired and in which the solar radiation is weak such as for example in areas with cloudy or rainy weather. Due to the natural circulation of water, the PVT passive system of the instant application may not require a pump and therefore may be cheaper and easier to build and maintain. Furthermore, generated electricity will not be wasted powering the pump.

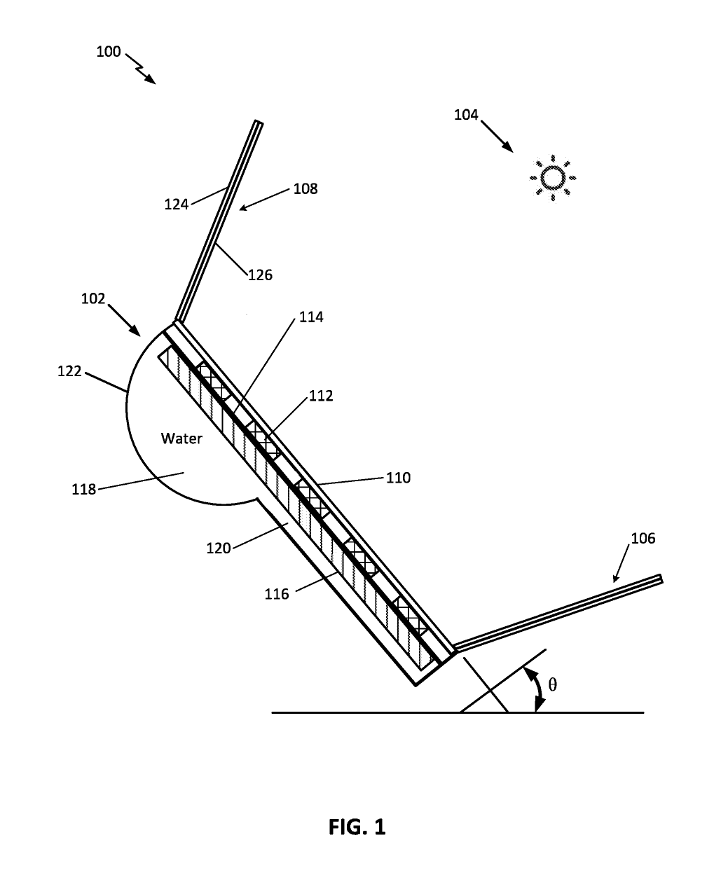

Reference now is made to the examples illustrated in the accompanying drawings and discussed below. FIG. 1 illustrates an exemplary PVT passive system 100 that can be used to generate both heat and electricity. The PVT passive system 100 may include a housing unit 102, a first adjustable reflector 106, a second adjustable reflector 108, a cover 110, a PV panel 112, an absorber plate 114, a fin panel 116, and a fluid collector storage 118. The housing unit 102 as shown integrates the PV panel 112, the absorber plate 114, the first adjustable reflector 106, the second adjustable reflector 108 and the fluid collector storage 118 into a single housing.

The cover 110 may be placed within the housing unit 102 over the PV panel 112. The cover 110 may include a glass cover. Alternatively, the cover 110 may include material other than glass, as long as the material is suitable for transferring the solar radiation to the PV panel 112 and the absorber plate 114.

A first adjustable reflector 106 can be located on a lower side of the housing and the second adjustable reflector 108 can be located on an upper side of the housing. The reflectors 106 and 108 focus the reflection of sunlight within the housing and on the photovoltaic cells. The reflectors' shape and arrangement provides the maximum use of the solar energy incident upon the PV panel 112. The reflectors 106 and 108 may be made of metal, plastic, ceramic, or glass are provided with inner surfaces 124 such as polished metal, mirrors or the like, so that light incident upon them will be directed upon the bottom of the energy collector. The outer surface 126 of the reflectors 106 and 108 may be made of insulating materials to reduce the heat dissipation.

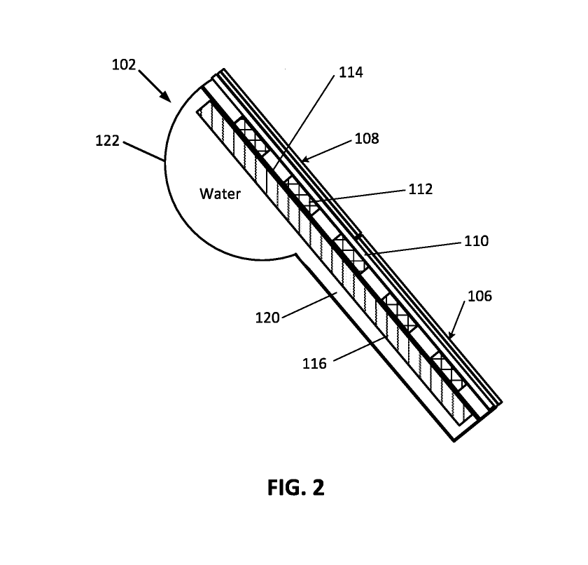

Referring to FIG. 2, the adjustable reflectors 106 and 108 may fold down and cover the entire housing via a bilayer of insulation when the sunlight does not strike, such as overnight and cloudy times, to reduce the heat transfer from the PV panel 112 to the outside and prevent the water heater's heat loss, therefore increase the efficiency of the PVT passive system 100. Re ectors play a role similar to the removable insulation cover on the collector outer glazing to reduce the heat losses during nights and cloudy times. Therefore, the use of removable insulation re ectors results in saving extra sensibly thermal energy.

The PV panel 112 may be placed within the housing unit 102 and may include a plurality of solar cells configured to generate an electrical output in response to incident electromagnetic radiations. Radiation from the sun 104 is incident on solar cells. The solar cells generate electrical power responsive to incident solar energy. In one implementation, the solar cells are spaced apart from each other under the glass cover 110 on the absorber plate 114.

The absorber plate 114 can be placed within the housing unit between the PV panel 112 and the fluid collector storage 118. The absorber plate can be configured to collect heat by absorbing electromagnetic radiation and to pass the collected heat to the fluid collector storage 118. To this end, the absorber plate 114 is configured to absorb the heat generated from the electromagnetic radiations incident on the plurality of the photoelectric cells 112 and incident directly on the absorber plate 114 due to existing space between the plurality of photoelectric cells. The absorbed heat is then passed to the fluid collector storage 118. The absorber plate 114 can be made, for example and without limitation, of aluminum or aluminum allow. This metal has thermal conductivity of 250 (W/mk). Thickness can be application-specific. One example thicknesses, for certain implementations can include, but is not limited to 0.002 (m). It will be understood that metals other than aluminum can be used, and that thicknesses less than and greater 0.002 (m) can be used. In one implementation, the PV panel 112 can be configured to convert only a small percentage of incident solar radiation to electricity and the rest is converted into heat. This can significantly increase the temperature of the PV panel 112 and reduce its productivity. The absorber plate 114 is configured to absorb this heat and thereby reduce the temperature of the PV panel 112 and increase its productivity.

The fluid collector storage 118 may include a water collector storage. The water collector storage may include a thermometer shape having a body portion 120 and a neck portion 122. The body portion 120 may be connected to the neck portion 122. The neck portion 122 may include half circular shape and the body portion 120 may include a rectangular elongated shape when viewed from a side of the PVT passive system 100. The neck portion 122 may be configured to store more water (higher volume) than the body portion 120. In one specific example, the neck portion 122 may be configured to store 4 times more water than the body portion 120.

The PVT passive system 100 may additionally include a fin panel 116. The fin panel 116 may be placed within the housing unit 102 between the absorber plate 114 and the fluid collector storage 118. The fin panel 116 is a surface that extends from the absorber plate 114 and is configured to increase the heat transfer from the absorber plate 114 to the water collector storage 118 by convection. In one specific example, the fin panel 116 can include parallel aluminum fins installed longitudinally back of the absorber plate 114 in the direction of the natural flow of the water to enhance the heat transfer rate and efficiency.

The fin panel 116 may separate the absorber plate 114 from the water collector storage 118. In this manner, the heat may be transferred from the absorber plate 114 to the water located at a top surface of the water collector storage 118 in direct contact with the fin panel 116 to thereby warm the water inside the water collector storage 118. In one implementation, the fin panel 116 can be a fin array, configured as an elongated one-piece element that includes a plurality of fins. The size and the number of the fins is application-specific.

The water located inside the body portion 120 may be heated faster than the water located a bottom surface of the neck portion 122. The convective movement of the water inside the water collector storage 118 may start when water in the body portion 120 is heated, causing the water in the body portion 120 to expand and become less dense, and thus more buoyant than cooler water in the bottom surface of the water collector portion (e.g., the water at the bottom of the neck portion 122) thereby replacing the cooler water in the bottom surface of the water collector portion. That is, the water inside the body portion 120 may be heated first and this heat may be transferred to the water at the bottom neck portion 122 via the described movement. In this manner, the water inside the water collector storage 118 circulates and becomes warm.

The PVT passive system 100 may be located on a house roof at an inclination angle facing the sun. The inclination angle, labeled “θ” on FIG. 1, is defined herein to mean: with respect to any flat collector surface, the angle formed between the horizontal (sometimes referred to herein as the “earth”) and a line perpendicular to the PV panel 112 in the direction of the sun. The inclination angle may be selected so as to maximize the amount of solar radiation incident in a perpendicular direction on the PV panel 112.

Other implementations are contemplated. For example, the PVT passive system of the instant application can be used to power and provide heated water for a single family home. To this end, a single or multiple small PVT passive systems may be mounted in the signal family home (e.g., on the roof) to simultaneously provide electricity and heated water for the single family home. The small PVT passive system may include a module with an absorber plate having a size of one or two square meter. For another example, the fluid collector storage may be covered by an insulator layer to prevent the heat from the fluid collector storage from escaping to the surrounding environment. In another implementation, the reflectors of the PVT passive system of the instant application may be covered by light sensors. Hence, each reflector may cover the entire housing automatically over night.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus the following claims are hereby incorporated into the Detailed Description, with each claim standing on its own as a separately claimed subject matter.

What is claimed is:

1. A photovoltaic-thermal device comprising:
a housing unit, having a first end and a second end;
a photovoltaic panel placed within the housing unit and including a plurality of photoelectric cells configured to generate an electrical output in response to incident electromagnetic radiations, the photovoltaic panel extending between the first end and second end of the housing;
a first adjustable angle reflector plate mechanically coupled to the first end of the housing and a second adjustable angle reflector plate mechanically coupled to the second end of the housing, wherein the first adjustable angle reflector plate and the second adjustable angle reflector plate are configured with adjustability to reflect solar energy onto the photovoltaic panel;
a fluid collector storage supported within the housing unit and configured to store fluid; and
an absorber plate supported within the housing unit between the photovoltaic panel and the fluid collector storage and configured to collect heat by absorbing electromagnetic radiations and to pass the collected heat to the fluid collector.

2. The photovoltaic-thermal device of claim 1, wherein the first adjustable angle reflector plate and the second reflector plate are configured to distribute solar energy substantially evenly over a surface of the photovoltaic panel.

3. The photovoltaic-thermal device of claim 1, wherein:
the first adjustable angle reflector plate and the second reflector plate are each configured to be foldable to a closed position, the closed position being face down toward the photovoltaic panel, and
the first adjustable angle reflector folds toward the photovoltaic panel and covers the entire photovoltaic panel and the second adjustable angle reflector folds toward the first adjustable angle reflector and covers the entire first adjustable angle reflector.

4. The photovoltaic-thermal device of claim 1, wherein in the folded position each of the first adjustable angle reflector plate and the second adjustable angle reflector plate is configured to cover the entire photovoltaic panel to decrease the heat dissipation at non-energy collection time.

5. The photovoltaic-thermal device of claim 4, wherein the first adjustable angle reflector plate and the second adjustable angle reflector plate reflectors each include a glass cover and an outer layer, the outer layer being a heat insulating material.

6. The photovoltaic-thermal device of claim 5, wherein the outer layer formed of heat insulating material is configured to reduce heat transfer from the housing unit when the first adjustable angle reflector plate and the second adjustable angle reflector plate are in the closed position.

7. The photovoltaic-thermal device of claim 1, further comprising a fin panel supported within the housing unit between the absorber plate and the fluid collector storage and configured to increase an amount of the transfer of the absorbed heat from the absorber plate to the fluid collector storage.

8. The photovoltaic-thermal device of claim 7, wherein the absorber plate separates the photovoltaic panel from the fluid collector storage.

9. The photovoltaic-thermal device of claim 1, wherein the fluid collector storage includes a water collector storage.

10. The photovoltaic-thermal device of claim 1, wherein the housing unit is configured for mounting on a house roof at an inclination angle.

11. The photovoltaic-thermal device of claim 10, wherein the inclination angle is selected to maximize an amount of solar radiation incident in a perpendicular direction on the photovoltaic panel.

12. The photovoltaic-thermal device of claim 1, wherein the photovoltaic-thermal device is configured to transfer heat from the absorber plate to the fluid storage collector without using a pump and a fluid pipe.

13. The photovoltaic-thermal device of claim 1, wherein the first and second reflectors are covered by a light sensor to automatically close at nights and cloudy times.

14. The photovoltaic-thermal device of claim 1, further comprising a sensor configured to detect an amount of radiation on the photovoltaic panel, wherein
when the incident electromagnetic radiations on the photovoltaic panel is less than 100 w/m2 within one minute, the first adjustable angle reflector plate and the second adjustable angle reflector plate are configured to close to prevent heat scape from the housing unit, and
when the incident electromagnetic radiations on the photovoltaic panel is equal or more than 100 w/m2 within one minute, the first adjustable angle reflector plate and the second adjustable angle reflector plate are configured to open to enable the absorber plate supported within the housing unit to collect heat by absorbing electromagnetic radiations and to pass the collected heat to the fluid collector.

15. The photovoltaic-thermal device of claim 14, wherein the sensor is installed on the first or second adjustable angle reflector plate.

16. The photovoltaic-thermal device of claim 15, wherein the first and second adjustable angle reflector plates are automatically opened and closes using the electromagnetic energy absorbed by the absorber plate.
